(19) United States
(12) Patent Application Publication
(10) Pub. No.: US 2008/0300887 A1
(43) Pub. Date: Dec. 4, 2008

(54) Usage Model of Online/Offline License for Asset Control

(76) Inventors: Hanying Chen, Shanghai (CN); Xiaofeng Sheng, Shanghai (CN); Teck Joo Goh, Johor (MY); Chih-Lung Hou, Shanghai (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/591,354

(22) PCT Filed: Dec. 30, 2005
(86) PCT No.: PCT/CN05/02405

§ 371 Date: Aug. 31, 2006

(51) Int. Cl. G06Q 20/00

(52) U.S. Cl. 705/1

(57) ABSTRACT

It is disclosed a method that may monitor and control loan instalment or other fee payment for an asset. The method may comprise checking validity status of a first license that comprises allowable usage information of a user device; and disabling use of the user device based on the validity status to control payment for the user device.

### BACKGROUND

In recent years, more and more people acquire computer systems through hire-purchase scheme. So far, once the machine is delivered to a buyer, there is no way to ensure the buyer pay money on time. Although the bank maintains the credit of the buyer, the punishment won't take effect until the buyer wants to use bank service again. In those countries where bank system is not advanced, rules can be easily broken by some users.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing device.

FIG. 2 illustrates an embodiment of a method that may be used for asset control.

FIG. 3 illustrates an embodiment of a system that may be used for a user to renew a license online.

### DETAILED DESCRIPTION

The following description describes techniques to provide a usage model for asset control. The implementation of the techniques is not restricted in computing systems; it may be used by any execution environments for similar purposes, such as, for example, other digital/electronic equipment. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. However, the invention may be practiced without such specific details. In other instances, control structures and full software instruction sequences have not been shown in detail in order not to obscure the invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

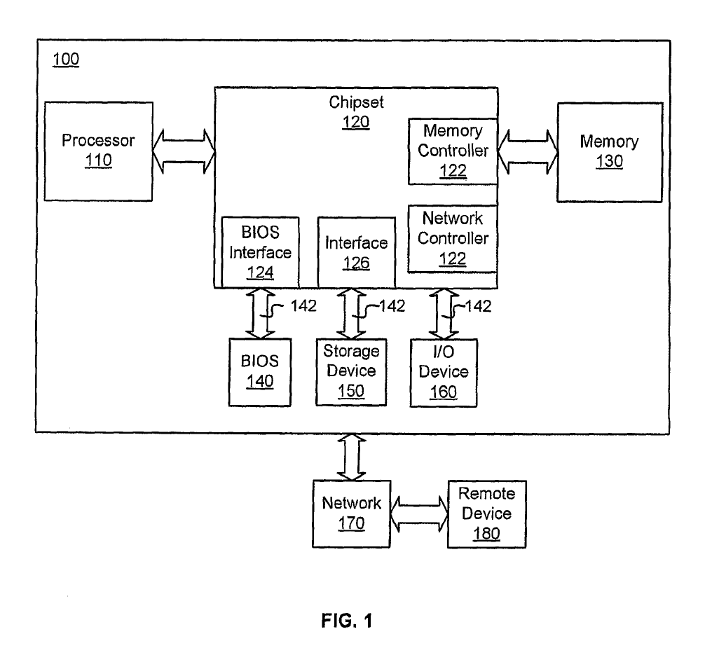

FIG. 1 shows an example embodiment of a computing device 100. The computing device 100 may comprise one or more processors 110 coupled to a chipset 120. The chipset 120 may comprise one or more integrated circuit packages or chips that couple the processor 110 to system memory 130, Basic Input/Output System (BIOS) 140, storage device 150, and one or more I/O devices 160 such as, for example, mouse, keyboard, video controller, etc. of the computing device 100.

Each processor 110 may implemented as a single integrated circuit, multiple integrated circuits, or hardware with software routines (e.g., binary translation routines). The processor 110 may perform actions in response to executing instructions. For example, the processor 110 may executes programs, perform data manipulations and control tasks in the computing device 100, etc. The processor 110 may be any type of processor adapted to perform operations in memory 130. For example, processor 110 may be a microprocessor, a digital signal processor, a microcontroller, or any other processors. In one embodiment, the processor 110 may be not dedicated to the use of memory 130, and the processor 110 may perform operations in memory 130 while also performing other system functions.

The memory 130 may comprise memory devices providing addressable storage locations. The memory 130 may comprise one or more different types of memory devices such as, for example, dynamic random access memory (DRAM) devices, synchronous dynamic random access memory (SDRAM) devices, read-only memory (ROM) devices, or any other volatile or non-volatile memory devices. The memory 130 may store instructions and codes represented by data signals that may be executed by processor 110.

The chipset 120 may receive transactions from the processors 110 and to issue transactions to the processors 110 via a processor bus. The chipset 120 may comprise a memory controller 122 that may read data from and/or write data to the memory 130 and/or issue transactions to the memory 130 via a memory bus. The chipset 120 may further comprise a storage device interface 126 that may access the storage device 150 via a bus 142. The storage device 150 may comprise a tape, a hard disk drive, a floppy diskette, a compact disk (CD) ROM, a flash memory device, other mass storage devices, or any other magnetic or optic storage media. The storage device 150 may store information, such as code, programs, files, data, applications, and operating systems.

The chipset 120 may further comprise one or more I/O interfaces (not shown) to access the I/O device 160 via buses 142 such as, for example, peripheral component interconnect (PCI) buses, accelerated graphics port (AGP) buses, universal serial bus (USB) buses, low pin count (LPC) buses, and/or other I/O buses. The I/O device 160 may include any I/O devices to perform I/O functions. Examples of the I/O device 160 may include controller for input devices (e.g., keyboard, mouse, trackball, pointing device), media card (e.g., audio, video, graphics), network card, and any other peripheral controllers.

In one embodiment, the BIOS 140 may comprise routines which the computing device 100 may execute. In another embodiment, the BIOS 140 may comprise routines or drivers which the computing device 100 may execute to communicate with one or more components of the computing device 100. In yet another embodiment, the computing device 100 may comprise a BIOS memory (not shown) to store BIOS code and data. The BIOS memory may be implemented with non-volatile memory devices, such as read-only memory (ROM) devices, flash memory, and any other memory devices. The BIOS may further contain a BIOS USB driver and other drivers. The BIOS 140 may be implemented with a firmware. In one embodiment, the. BIOS 140 may comprise a legacy BIOS, extensible firmware interface (EFI) BIOS, or other BIOS. The chipset 130 may comprise a BIOS interface 124 that may access the BIOS 140 via a bus 142.

In one embodiment, the computing device 100 may communicate with a remote device 180 via a network 170. The chipset 130 may comprise a network controller 128 to control the communication between the computing device 100 and the networks 170 via, for example, a network card, etc. In one embodiment, the computing device 100 may communicate with a different number of remote devices via a different number of networks.

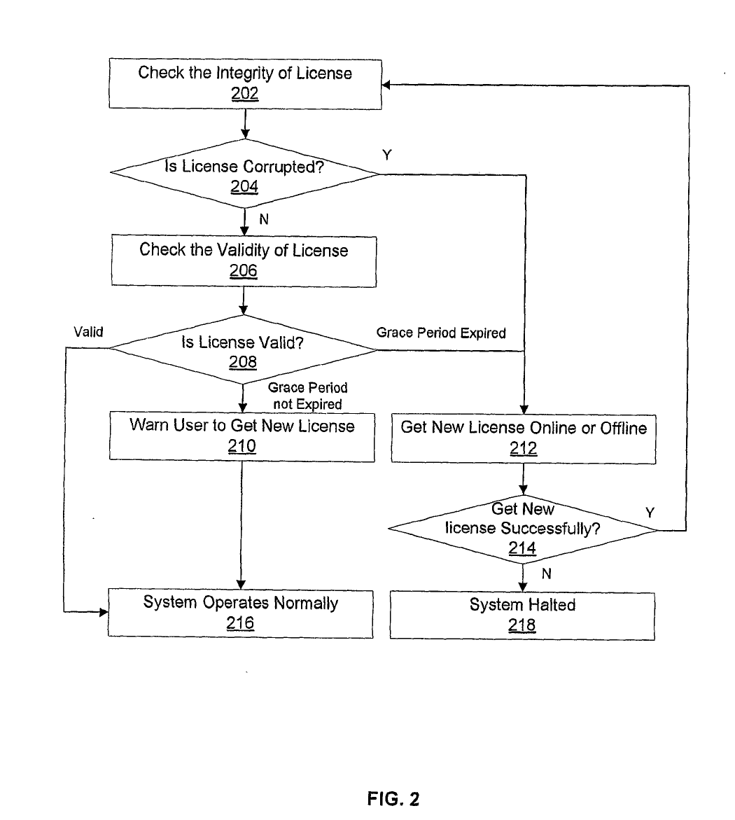

FIG. 2 illustrates an example embodiment of a method that may be used for asset control. In the following, the method of FIG. 2 may be described with regard to, for example, the computing device 100 as shown in FIG. 1. However, in some embodiments, the method of FIG. 2 may be used on other digital/electronic equipment, etc. In block 202, the processor 110 may check integrity of a license for a computing device 100, for example, in response to the computing device 100 is powered on. In one embodiment, a user may loan the computing device 100 from a bank or a service provider.

In one embodiment, the license may comprise code, information, data, or a file that may be stored on a storage device 150 of the computing device 100. The license may comprise information associated with the computing device 100. For example, the license may comprise a time stamp. For another example, the license may comprise information on when the license is issued and/or when the license will expire. The license may further comprise a grace period that may indicate how long the user is allowed to further use the computing device 100 after the license expires. In another embodiment, the license may comprise information that may indicate how long or how much times the user is allowed to use the computing device 100. However, in other embodiments, the license may comprise different information that restricts or allows a user to use the computing device 100.

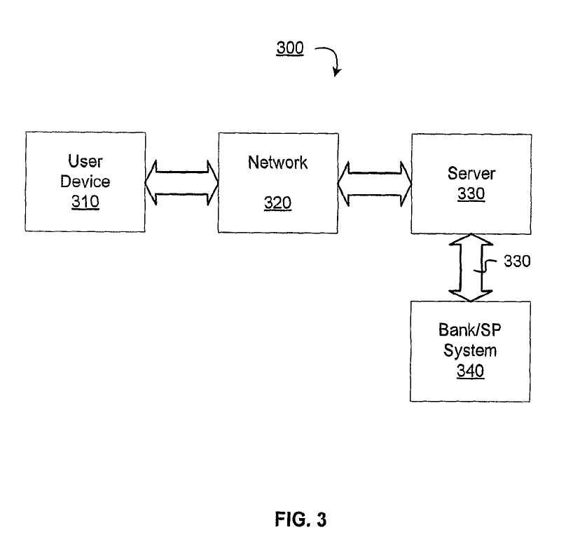

In another embodiment, the license may comprise restriction or permission information based on how a user uses a user device. For example, for an MP3, the license may comprise information on how many songs or files the MP3 is allowed or restricted to play. For another example, the license may comprise information that may allow or restrict a volume associated with each song or file. The license may further comprise information on how long each song or file is allowed or restricted to play. In yet another embodiment, a bank system (for example, 340 as shown in FIG. 3) may encrypt the license and/or embed one or more characters or attributes in the license to avoid users deleting or modifying the license. In another embodiment, the license may be stored in a storage device 150 in a hiding mode to prevent users from locating the license.

In one embodiment, the license may be stored in a form of binary code. In another embodiment, the license may comprise information to authenticate or verify the integrity of the license. For example, the information may be attached to the license. The information may comprise an authentication code that may be obtained or calculated by applying an algorithm on the license. In one embodiment, the authentication code may be stored in a form of binary code. However, in other embodiments, the license may have a different form, and/or may comprise different data to check the integrity or completeness of the license.

For example, in block 202, in order to check the integrity of the license, the processor 110 may apply the algorithm associated with the authentication code to the license to obtain a result. The processor 110 may compare the result with the authentication code. The processor 110 may determine that the license is a complete one, in response to determining that the comparison between the result and the authentication code is successful based on a condition or a criterion, e.g., the result matches or equals to the authentication code. On the contrary, the processor 110 may determine that the license is corrupted, in response to determining that, for example, the result does not match or is unequal to the authentication code. However, in other embodiments, the processor 110 may check the integrity of the license in a different manner. For example, the processor 110 may execute a handshake operation on the license to verify the integrity, e.g., with a server 330 or a bank/service provider system 340 as shown in FIG. 3.

In block 204, the processor 110 may check whether the check result of block 202 indicates a complete license or a corrupted license. In response to determining that the license is a complete one, the processor 110 may further check the validity of the license (block 206). On the contrary, the flow may proceed to block 212, in response to determining that the license is corrupted from the check result of block 202.

In block 206, the processor 110 may check the validity of the license. In one embodiment, the processor 110 may compare the current date with the information embedded in the license to determine whether the license has expired. For example, the processor 110 may compare the current date with the information on when the license is issued to determine how many days have passed from the issue date. The processor 110 may further determine whether the number of days is larger than a threshold that may be corresponding to the expiration period. The bank system 340 may preset the threshold and embed it in the license before issuing the license to the user. For another example, the processor 110 may compare the current date with the information on when the license will expire to determine whether the current date is earlier than the expiration date. In another embodiment, the processor 110 may determine whether a number of times that the user has used the computing device 100 exceeds a predetermined value that may be embedded in the license.

In block 206, the processor 110 may have a check result that the license is valid, in response to determining that the number of days between the current date and the issue date of the license is no larger than the threshold. In another embodiment, the processor 110 may have a check result that the license is valid, in response to determining that the current date is earlier than the expiration date or on the same date as the expiration date. In yet another embodiment, the check result of block 206 may indicate that the license is valid, in response to determining that the number of usage times is smaller than the predetermined value. However, in some embodiments, the processor 110 may determine the validity of the license based on a different condition depending on how the user uses the computing device 100 or other user device. For example, for an MP3, the processor 110 may determine that the license is valid, in response to determine that the volume of each song or file stored in the MP3 is smaller than a determined volume. In another embodiment, the processor 110 may determine that the license is valid, in response to determine that the number of songs or files that were played by the MP3 does not exceed an allowable or limited value, etc.

In block 206, in response to determining that the license is invalid, the processor 110 may further check whether the computing device 100 may still be used. In one embodiment, the processor 110 may further determine whether a grace period has expired. For example, the bank system 340 may embed the grace period in the license previously. In one embodiment, the processor 110 may compare the current date with the grace period to determine whether the current date is earlier than the last day of the grace period. The processor 110 may determine that the grace period has expired, in response to determine that the current date is later than the last day of the grace period. In block 208, the processor 110 may determine the check result obtained in block 206. For example, in block 208, in response to the check result of block 206 indicates that the grace period has expired, the flow may proceed to block 212. On the contrary, in response to the check result indicates that the grace period has not expired, the flow may go to block 210.

In another embodiment, the processor 110 may compare a predetermined number of times that a user is allowed or limited to use a loaned device with a number of real usage times of the computing device 100. The predetermined number of times may correspond to the grace period. In block 208, in response to determining that the check result of block 206 shows the number of real usage times exceeding the predetermined number, the flow may proceed to block 212. On the contrary, the processor 110 may go to block 210, in response to determining the check result of block 206 shows that the number of real usage times is not larger than the predetermined number (block 208). In some embodiments, the processor 110 may use a different condition or criterion to determine whether the computing device 100 may still be used, in response to an invalid license.

In block 210, the processor 110 may warn the user to get a new license. In one embodiment, the processor 110 may send the user information, a signal, or a notice, or the like, that may indicate the invalidity of the license and may ask the user to get the new license within the grace period. In another embodiment, the processor 110 may notify the user of the last day of the grace period or how long the user may use the computing device 100. In yet another embodiment, the processor 110 may provide the user with information on how to get the new license. However, in some embodiments, the processor 110 may send other information associated with license renewal. In another embodiment, the block 210 may be omitted. In block 208, in response to the check result of 206 showing that the license is valid, or the computing device 100 may still be used with an invalid license, and/or in response to warning the user, the computing device 100 may operate normally (block 216). In one embodiment, the processor 110 may execute a boot sequence to enable the user to use the computing device 100.

In block 212, in response to determining that the grace period has expired completely or the license is corrupted, the user may choose to get a new license online or offline. In another embodiment, the online or offline mode may be predetermined by the computing device 100 or the bank system 330 as shown in FIG. 3. FIG. 3 illustrates an embodiment of a system that may be used to get the new license online. Referring to FIG. 3, the system 300 may comprise one or more user device 310. In one embodiment, the user device 310 may comprise a computing device, a digital device, an electronic device, or any other devices that may be loaned or borrowed from a bank or any other service providers. In another embodiment, the user device 310 may comprise a processor, a CPU, or any other processing unit that may check the integrity and/or validity of a license that stored on the user device 310. The user device 310 may communicate with one or more servers 330 via one or more networks 320. In one embodiment, the server 330 may be remote to the user device 310. The network 320 may comprise a cable network, a wired network, a wireless network, a local area network (LAN), a wide area network (WAN), a Bluetooth network, Internet, World Wide Web, or any other networks. In another embodiment, the user device 310 and/or the remote server may link to the network 320 via a network cable, wirelessly, or in other ways. As shown in FIG. 3, the remote server 330 may link to one or more bank systems 340 that loan user devices 310 to users; however, some embodiments may use a different system of a service provider (SP) that may help users to get loan for user devices 310 by matchmaking with the bank, or may lend user devices 310 to users for them to use the services provided by the SP.

Referring to FIG. 3, in response to determining that the license stored in the user device 310 is corrupted and/or invalid or the grace period has expired, or the user device 310 is not allowed to be further used, the user device 310 may send a request for the new license to one or more remote servers 330 via one or more networks 320 in an online mode. In one embodiment, the remote server 330 may transmit the request to the bank/SP system 340. In another embodiment, the remote server 330 may ask the bank/SP system 340 to check payment status on the user device 310. For example, the bank/SP system 340 may check whether a user with the loan of the user device 310 has paid bank instalment for the user device 310 and/or internet fee. In another embodiment, the bank/SP system 340 may check whether a user that uses the services provided by the bank/SP system 340 has paid the service usage fee and/or internet fee. The bank/SP system 340 may provide or send information on the payment status to the remote server 330. The remote server 330 may issue the new license to the user via one or more networks 320, in response to determining that the payment is confirmed by the bank. The user device 310 may download the new license issued by the remote server 330 to update the corrupted or invalid license.

In another embodiment, in block 212, the user may obtain the license offline. For example, the user may go to a license issue agent to get an offline certificate, for example, saved on a medium to update the corrupted or invalid license manually. In another embodiment, the user may buy a fee charging card that may be distributed by the bank or the service provider for a user to pay the instalment and/or any other service fee offline. The fee charging card may comprise a password to confirm the payment of corresponding fee. For example, the fee charging card may be implemented by paper, a magnetic card, an IC card, or any other medium. In yet another embodiment, the user may buy a medium that may store the new license. For example, the medium may comprise an encrypted disk or any other media, etc. The user may load the new license from the medium into the computing device 100 or other user devices. In yet another embodiment, the user may call a hotline of the bank or service provider to pay the bank instalment and/or service fee, so as to renew the corrupted or invalid license.

In block 214, the processor 110 may determine whether the user gets a new license successfully in block 212. For example, the user may be failed to get or download the new license, in response to the payment status showing that the user has not paid corresponding fee or the payment has not been confirmed. In another embodiment, the new license may be unavailable, if the user does not go to get the license offline. The processor 110 may halt or disable use or operation of the computing device 100, in response to determining that new license has not been obtained successfully (block 218). For example, the processor 110 may not initiate a boot sequence, so that the computing device 100 can not work. On the contrary, the processor 110 may proceed to block 202 to check the new license, in response to determining that the new license is available or the user has got the new license. In another embodiment, the flow may proceed to block 216, wherein the processor 110 may boot up to operate normally, in response to getting the new license successfully.

While the method of FIG. 2 is illustrated as a sequence of operations, the processor 110 in some embodiments may perform illustrated operations of the method in a different order. In one embodiment, a license may not use a grace period, so that the processor 110 may omit the operations regarding the grace period checking. In another embodiment, the processor 110 may further ask the user whether to choose update an invalid license immediately in response to a warning or later. While the method of FIG. 2 is illustrated as implemented in the computing device 100, some embodiments may apply to different user devices. In another embodiment, the computing device 100 or the user device 310 may execute a program to monitor whether the user changes the system time or clock. The computing device 100 or the user device 310 may ask the user to update or renew the current license or halt or disable use of the device, in response to determining that the system time has been changed to be later than the expiration date of the license or the grace period, etc.

While certain features of the invention have been described with reference to embodiments, the description is not intended to be construed in a limiting sense. Various modifications of the embodiments, as well as other embodiments of the invention, which are apparent to persons skilled in the art to which the invention pertains are deemed to lie within the spirit and scope of the invention.

What is claimed is:

1. A system comprising:
a storage device to store first information that indicates whether the system is allowed to be used; and
a processor to disable use of the system based on the first information to control payment associated with the system.

2. The system of claim 1 wherein the processor further to get new information to renew the first information based on the integrity of the first information.

3. The system of claim 1 wherein the processor further to get new information to update the first information, in response to determining that the first information is corrupted.

4. The system of claim 3 wherein the processor further to halt the booting of the system, in response to determining that the new information is unavailable.

5. The system of claim 1 wherein the processor further to, in response to determining that the current date is later than an expiration date in the first information, get information on a new expiration date based on a payment status of the system.

6. The system of claim 1 wherein the processor further to disable the use of the system, in response to being failed to get a new expiration date to renew the first information.

7. The system of claim 1 wherein the processor further to get new information for renewing the first information, in response to determining from the first information that a grace period for allowing using of the system has expired.

8. The system of claim 7 wherein the processor further to enable the use of the system, in response to determining that the new information for renewing the first information is available.

9. The system of claim 7, wherein the processor further to enable the use of the system based on integrity and validity of the new information.

10. The system of claim 1 wherein the processor further to enable the use of the system, in response to determining that the first information is invalid and the invalid information indicates that the system is allowed to be further used.

11. The system of claim 1, wherein the processor further to enable the use of the system, in response to determining that the first information is valid.

12. A method, comprising:
checking validity status of a first license that comprises allowable usage information of a user device; and
disabling use of the user device based on the validity status to control payment for the user device.

13. The method of claim 12 further comprising:
comparing current time with expiration time set in the first license to obtain the validity status.

14. The method of claim 12 further comprising:
comparing a number of usage times of the user device with a allowable number in the first license to check the validity status.

15. The method of claim 12 further comprising:
getting a new license to update the first license, in response to determining that the first license is corrupted; and
checking a validity status of the new license.

16. The method of claim 12 further comprising:
in response to determining that the first license is invalid, getting a new license to update the first license, depending on payment status associated with the user device.

17. The method of claim 16 further comprising:
disabling the use of the user device, in response to determining that the new license is unavailable.

18. The method of claim 12 further comprising:
downloading a new license from a remote server to update the first license, in response to determining that a grace period comprised in the first license has expired;
disabling the use of the user device, in response to determining that the downloading of the new license is failed.

19. A system comprising:
a user device that stores a license, wherein the license comprises expiration information on the user device; and
a server that issues the license for the user device based on payment status of the user device.

20. The system of claim 19, further comprising:
a network that couples the user device with the server.

21. The system of claim 19, further comprising:
a bank system that monitors payment status of the user device.

22. The system of claim 19, wherein the user device further to
check the validity of the license, in response to determining that the license is a complete one.

23. The system of claim 19, wherein the user device further to
compare a number of usage times of the user device with a value in the expiration information to check the validity of the license.

24. The system of claim 19, wherein the user device further to
in response to determining that the license is invalid, request for a new license from the server.

25. The system of claim 24, wherein the server further to
ask for the payment status from a bank system; and
issue the new license to the user device, in response to determining that the payment is confirmed by the bank system.

26. The system of claim 24, wherein the user device further to
getting the new license, in response to the server issuing the new license; and
checking the validity of the new license.

27. The system of claim 24, wherein the user device further to
disable use of the user device, in response to determining that the new license is unavailable.

28. A machine readable medium comprising a plurality of instructions that in response to being executed result in a computing device
halting use of the computing device based on a license stored in the computing device to control payment of the computing device, wherein the license comprises expiration information on the computing device.

29. The machine readable medium of claim 28, further comprising a plurality of instructions that in response to being executed result in a computing device
in response to determining that the license is corrupted, getting a new license to update the corrupted license.

30. The machine readable medium of claim 28, further comprising a plurality of instructions that in response to being executed result in a computing device
in response to determining that the license has expired, getting a new license to renew the expired license based on payment status of the computing device.

31. The machine readable medium of claim 28, further comprising a plurality of instructions that in response to being executed result in a computing device
in response to determining that the license is in a grace period, issuing a warning for getting a new license.

32. The machine readable medium of claim 28, further comprising a plurality of instructions that in response to being executed result in a computing device
in response to determining that a grace period for the license has expired, downloading a new license based on payment status of the computing device.

33. The machine readable medium of claim 32, further comprising a plurality of instructions that in response to being executed result in a computing device
downloading the new license, in response to determining that the payment of the computing device is confirmed; and
checking the validity of the new license.

34. The machine readable medium of claim 33, further comprising a plurality of instructions that in response to being executed result in a computing device
disabling the use of the computing device, in response to determining that the new license is unavailable.

35. The machine readable medium of claim 28, further comprising a plurality of instructions that in response to being executed result in a computing device
enabling the use of the computing device, in response to determining that the license is valid.
